(19) United States
(12) Patent Application Publication
(10) Pub. No.: US 2018/0210928 A1
(43) Pub. Date: Jul. 26, 2018

(54) VISUALIZATION OBJECTS IN A MULTI-DISCIPLINE SYSTEM

(71) Applicant: Siemens Aktiengesellschaft, München (DE)

(72) Inventors: Marine Durel, Long Beach, CA (US); Attila Labas, Rancho Mission Viejo, CA (US); Oswin Noetzelmann, Diamond Bar, CA (US); Christopher Patrick Portway, JR., Long Beach, CA (US); Rami Reuveni, Irvine, CA (US); Daniela Stederoth, Newport Beach, CA (US)

(21) Appl. No.: 15/747,644

(22) PCT Filed: Sep. 28, 2015
(86) PCT No.: PCT/US2015/052586

§ 371 Date: Jan. 25, 2018

(51) Int. Cl. G06F 17/30

(52) U.S. Cl. CPC G06F 17/30554; G06Q 10/101; G06F 17/30604; G06F 17/30309

(57) ABSTRACT

A system and a method for visualizing related data in a multidisciplinary engineering system 60 are provided. A visualization of a multi-discipline system 60 based on a meta model is controlled by input from a user. A display on a visualization unit 69 is updated according to an input received from an input device 65.

### TECHNICAL FIELD

The present disclosure is directed, in general, to engineering systems, computer-aided design, visualization, and manufacturing systems, product data management (PDM) systems, product lifecycle management (“PLM”) systems, and similar systems, that manage data for products and other items (collectively referred to herein as systems).

### BACKGROUND OF THE DISCLOSURE

Generally systems that manage large complex data may benefit from improvements. Such complexity may be included many interconnections and dependencies in the data.

### SUMMARY OF THE DISCLOSURE

Variously disclosed embodiments include systems and methods that may be used to duplicate an object in a system that manages data for multiple disciplines. In one example, a system is provided. The system includes a processor, a visualization unit an associated with the processor, and a storage unit associated with the processor. The storage unit comprising data for multiple disciplines and a meta model. The processor configured to retrieve data from and to store data on the storage unit process an input controlling visualization based on the meta model and to update a display on the visualization unit based on the input received from an input device.

In another example, a method is provided. According to the method, Input is received to control a visualization of a multi-discipline system based on a meta model; and the display on the visualization unit is updated according to an input received from an input device.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the Detailed Description below, it may be advantageous to set forth definitions of certain words or phrases that may be used throughout this patent document. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

In addition, phrases such as “processor is configured to” carry out one or more functions or processes, may mean the processor is operatively configured to or operably configured to carry out the functions or processes via software, firmware, and/or wired circuits. For example a processor that is configured to carry out a function/process may correspond to a processor that is actively executing the software/firmware which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may correspond to a processor circuit particularly fabricated or “wired” to carry out the functions or processes (e.g., an ASIC or FPGA design).

Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

Reference is made to the drawings, wherein elements having the same reference character designations represent like elements throughout, wherein

FIG. 1 illustrates an example of a general overview of a multi-disciplinary engineering system;

FIG. 2 illustrates relationships between nodes in a hierarchy.

FIG. 3 illustrates discipline artifacts of a node.

FIG. 4 illustrates a multi-discipline node.

FIG. 5 a multi-disciplinary object perspective of FIG. 3.

FIG. 6 illustrates an embodiment of multi-disciplinary system.

FIG. 7-18 illustrates embodiments of visualization data in multi-disciplinary system.

### DETAILED DESCRIPTION OF THE DRAWINGS

Various technologies that pertain to systems and other data intensive applications will now be described with reference to the drawings, where like reference numerals represent like elements throughout. The drawings discussed below, and the various embodiments used to de-scribe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system components may be performed by multiple components. Similarly, for instance, a component may be configured to perform functionality that is described as being carried out by multiple components. The numerous innovative teachings of the present application will be described with reference to exemplary non-limiting embodiments.

Many forms of data, such as engineering data can be very complex. In a project requiring people from multiple disciplines the data may be separated, for example, by discipline.

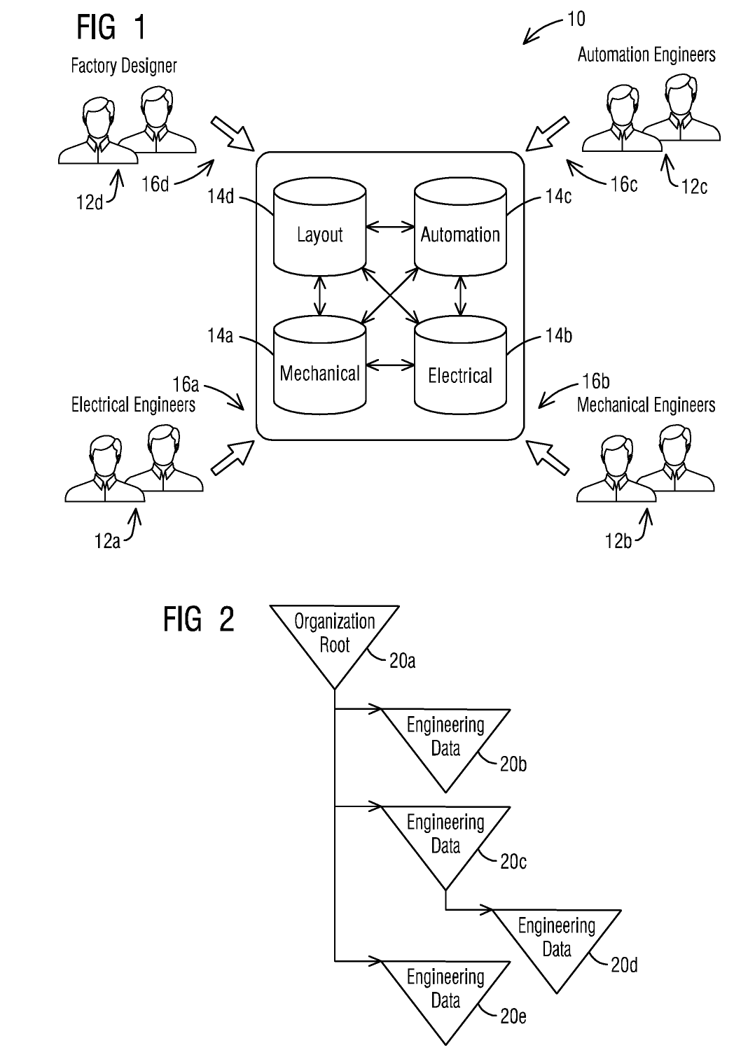

FIG. 1 illustrates an example of a multi-disciplinary engineering system 10. In the example, shown in FIG. 1, the engineering system 10 refers to a production line in a factory and with users 12a-d from multiple disciplines 16 such as electrical engineering 16a, mechanical engineering 16b, automation engineering 16c and factory design 16d. Users such as electrical engineers 12a, mechanical engineers 12b, automation engineers 12c and factory designers 12d. have access to data 14a-14d which is stored in the multi-disciplinary engineering system 10. Each discipline includes data 14a-14d with information respective to that discipline 16. Thus, users 12a-12d of different disciplines 16 each has a different view of the project which is specific to the respective discipline.

The data 14a-14d may pertinent to a physical device, a behavior, a condition or any data pertinent to the project. Related data may be represented within different view in which the data has a different representation based on the respective discipline. The organization of the data may differ based on the discipline. The organization of the data is structured to provide con-texts, relations and to allow finding the correct data quickly when the data is needed.

For example a hierarchical structure may be used, where a discipline may have one or more hierarchical structure of their data. FIG. 2 illustrates hierarchy structure of data organized within nodes 20a-20e. Each node 20a-20e in the hierarchy may include large amounts of data 14 capable of describing complex engineering aspects. For example, a three-dimensional Computer Aided Design (CAD) model, two-dimensional plans, complex data sheets. A node in a specific discipline 16 is referred to hereinafter as a discipline specific facet or a discipline artifact. The node may represent smaller entities such as a symbol on a sheet or a variable in a PLC program.

A node is a parent, also known as parent node, when further nodes are hierarchically arranged below the parent node. Nodes arranged under a parent without any intervening nodes are children and are also known as child nodes. The child node could also be a parent node. Thus forming a grandparent, parent and grandchild relationship from the perspective of the grandparent, where the parent node intervenes between the grandparent node and the grandchild node. For simplification, all nodes whether included as a child with or without any intervening nodes are considered hereinafter as child nodes. Similarly, all nodes including a child with or without any intervening nodes an node are considered hereinafter as parent nodes.

Regarding the illustration in FIG. 2, node 20a is a parent to nodes 20b-20e. Child node 20b, 20c and 20e are included by parent node 20a without any intervening nodes, whereas child node 20d is included by parent node 20a with intervening node 20c. Furthermore node 20d is a child of node 20c.

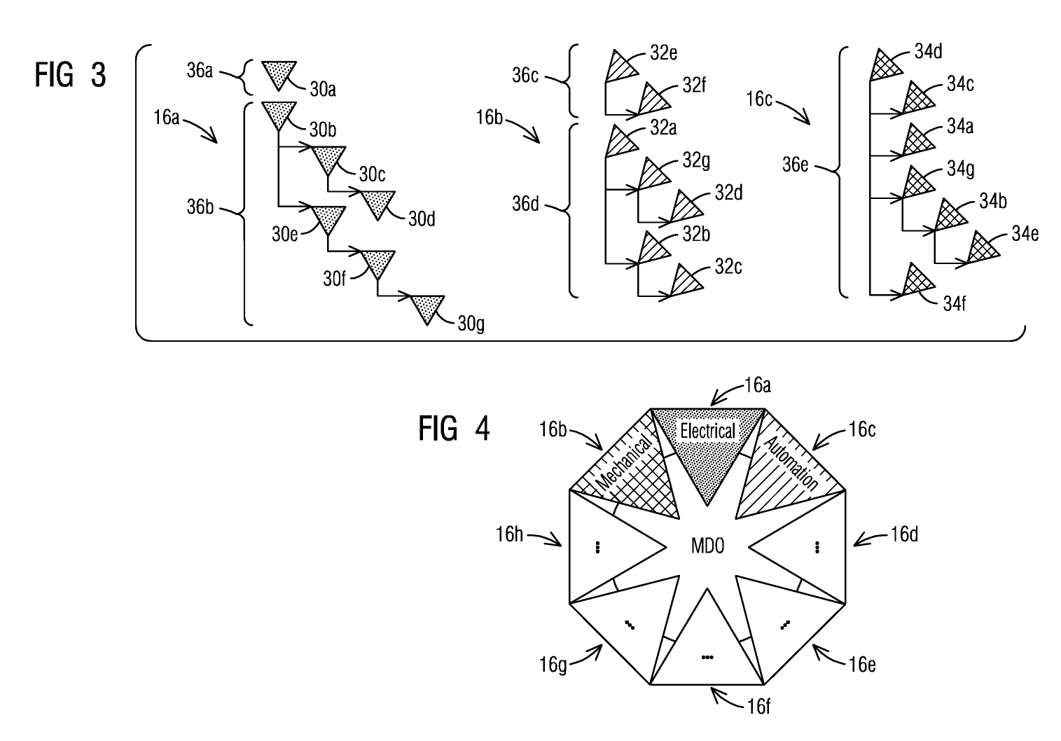

FIG. 3 illustrates different disciplines 16a-16c and their respective discipline artifacts 30, 32, 34. According to the illustration, the organization of the data differs for each discipline 16; discipline 16a includes discipline artifact 30a in a first hierarchical structure 36a and discipline artifacts 30b-30g in a second hierarchical structure 36b; discipline 16b includes discipline artifacts 32e-32f in a first hierarchical structure 36c and discipline artifacts 32a-32d, and 32g in a second hierarchical structure 36d; and discipline 16c includes discipline artifact 30a-30e in a single hierarchical structure 36e.

A connecting factor between the disciplines is that certain nodes of data in a discipline correspond to one or more nodes in data organization of another discipline. This correspondence is described by a common language, meta model, which is used by the disciplines for the hierarchical organization and for combining the nodes to form the multi-disciplinary object (MDO). FIG. 4 illustrates a MDO 40 with nodes different disciplines 16 and their respective discipline artifacts.

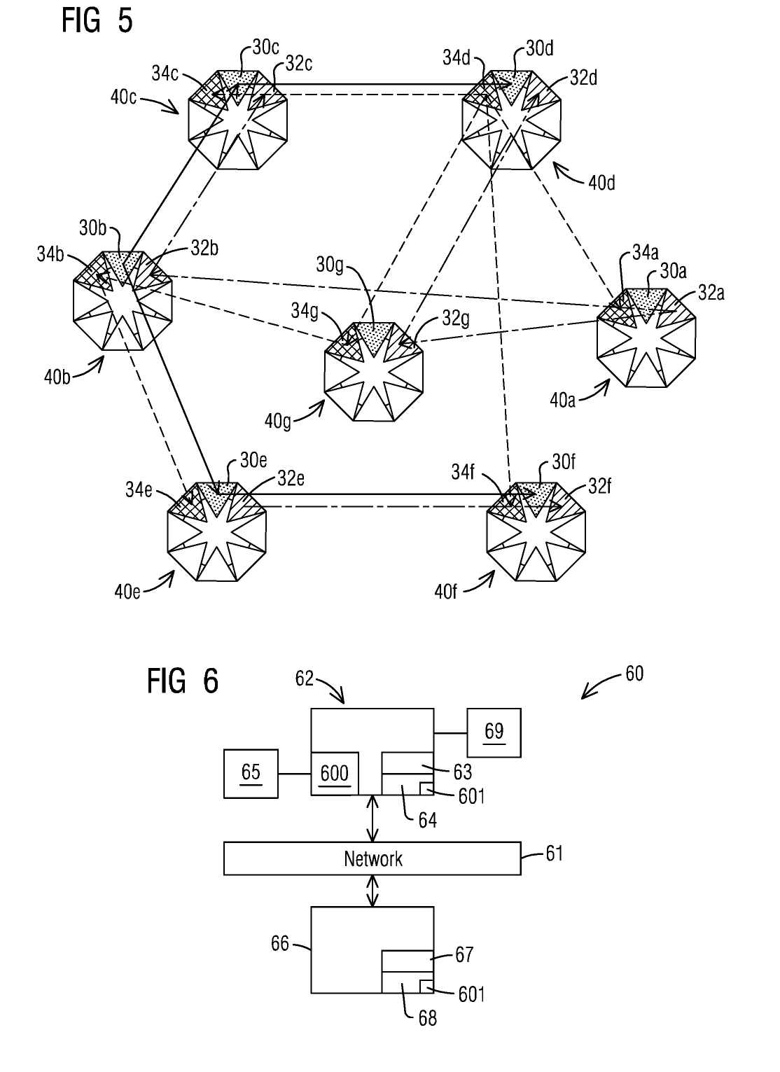

FIG. 5 illustrates a MDO perspective of FIG. 3. Each MDO 40 includes discipline artifacts 30, 32, 34. According to the illustration, a directional line indicates the association between discipline artifacts 30, 32, 34 thereby providing a hierarchical relationship as shown in FIG. 3. Accordingly, discipline artifact 30a is not associated to another discipline artifact forming hierarchical structure 36a. Discipline artifacts 30b-30g form hierarchical structure 36b where discipline artifact 30b is associated with discipline artifact 30c and discipline artifact 32e. Discipline artifact 30c is associated with discipline artifact 30d and discipline artifact 30e is associated with discipline artifact 30f which is associated with discipline artifact 32g. Discipline artifacts 32e-32f form hierarchical structure 36c where discipline artifact 32e is associated with discipline artifact 32f. Hierarchical structure 36d is formed from discipline artifacts 30a-30d, and 30g, where discipline artifacts 30a is associated with discipline artifacts 30g and 30b, discipline artifact 30g is associated with discipline artifacts 30d and discipline artifact 30b is associated with discipline artifacts 30c. Discipline artifacts 34a-g forms a hierarchical structure 36e, where discipline artifact 34d is associated with discipline artifacts 34c, 34a, 34g, and 34f. Discipline artifact 34g is associated with discipline artifact 34b which is then associated with discipline artifact 34e.

The meta model provides a model of a model. Such aspects as rules, constraints associates and other data to model the multi-discipline engineering system are provided by the meta model. For the multi-discipline system, the meta model may be highly complex. At least in the complexity it may be, at best, difficult for a user of the system the system to understand. Further, the meta model is intended for computer interpretation and not easily interpreted by a user. For example, the meta model may include information useful to the computer or a database such as addresses, links, and relational associations.

A visual interpretation of the meta model in regards to various aspects the multi-disciplinary system, referred to herein after as visualization, is described below in various embodiment. In contrast to the normal user interaction of the multi-disciplinary system, which is in regards to one specific discipline in the system, the visualization provides a graphical representation of data between multiple disciplines.

Information in the meta model is used to provide the graphical representation which may include any data for the multi-disciplinary system. For example, a graphical representation may include nodes, edges between nodes, data associated with nodes.

While the visualization is described using specific graphical user interfaces (GUI), such as check boxes and markers, one skilled in the art would understand this is merely for illustration. Any other graphical user interface may be used such as drop downs, icons or radio buttons. Additionally interfaces other than a GUI may be used such as command line. The interface provides a user the ability to control items to be displayed.

Referring to FIG. 6, a multidiscipline system 60 is illustrated. The system 60 includes a computer 62 associated with a server 66. Communication between the computer 62 and the server 66 may be via a network 61 capable of transmitting data. For example, a network defined by area such as local area networks (LAN), wide area networks (WAN), or various other networks such as a private, personal or virtual network. The data regarding the disciplines and/or meta model may be transmitted to the computer 62 via the network 61 as needed. For example, after an input is received to change the visualization.

The server 66 includes a processor configured 67 to perform functions of the multi-disciplinary system and storage unit 68 to store data for the disciplines and the meta-model 601.

A visualization unit 69, such as a TV, monitor, projector or any other suitable device to display data to the user of the computer 62 is associated with the computer 62. An input device 65, such as a keyboard, touch screen, mouse, touch-screen, voice recognition is associated with the computer 62 to allow the user to interact with the user interface 600. Computer 62 includes storage unit 64 and processor 63, which is configured to retrieve data regarding the meta model 601. The processor 63 is further configured to execute program code stored in the computer 62. The computer 62 receives input from the user via the input device 65 and the user interface 600. The input controls the display so that the visualization of information in meta model 601 changes according to the input. Further the interpretation of the data and/or meta model for visualization may be handled by the computer 62, the server 66 or distributed between the devices.

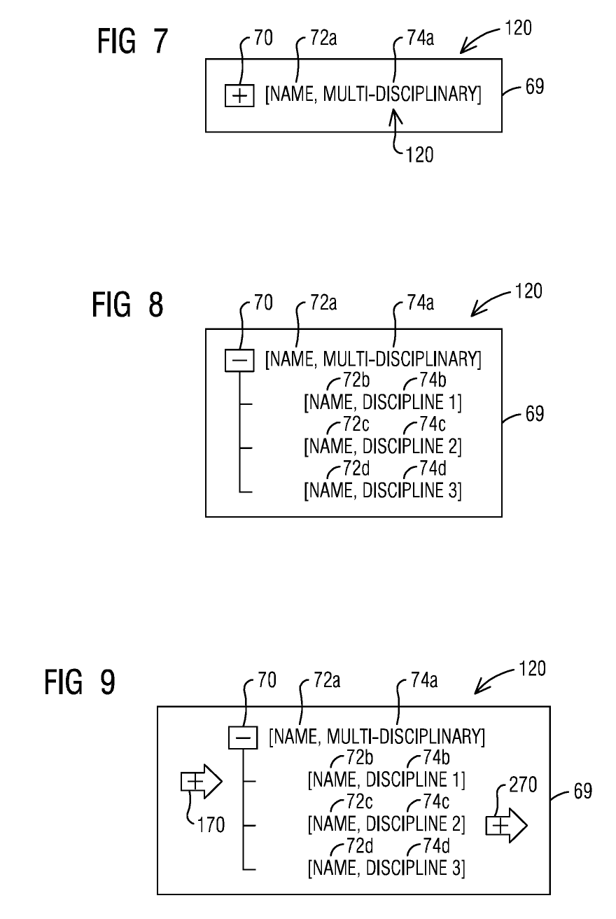

FIGS. 7-18 illustrate embodiments of a visualization of data in the multi-disciplinary system. Data in the meta model used to create the visualization. In the illustration of FIG. 7 a node is displayed on the visualization unit 69 of the multi-disciplinary system.

An identifier 72a of the node is displayed. According to the example, the identifier is the text name of the node or discipline artifact.

A marker 70 may be provided to depict the state of node. The node may be closed or open. When in the closed state, constituents of the multi-disciplinary object are not displayed. In contrast, when in the open state, at least the constituents of the multi-disciplinary object are displayed.

According an embodiment the maker includes a “+” or a “−” symbol, where “+” indicates node is in a closed state and that more information is available regarding the node. In contrast the “−” symbol indicates a node is in the open state. Node 120 in the illustrated embodiment of FIG. 7 is in a closed state.

An indicator 74a may be provided to indicate a relationship between the node and the multi-discipline system or a specific discipline (discipline artifact). In the illustration, the indicator 74a is text “MULTI-DISCIPLINARY” indicating the indicator 72a displayed is in regards to the multi-discipline system as a whole and not for a discipline artifact.

By way of the input device 65, a user may control aspects of the visualization. For example, a change could be made to the state of node via the input device 65. In this case the state could be changed from closed to open.

Referring to FIG. 8, an embodiment of the node 120 in FIG. 7 is showed in an open state. In this example, the node is pertinent to several disciplines which are displayed. “DISCIPLINE 1”, “DISCIPLINE 2” and “DISCIPLINE 3” as indicated by indicators 74b-74d represent the discipline for the respective discipline artifact 72b-72d. For example, discipline artifact 72b may be in regards to a mechanical engineering discipline 74b, discipline artifact 74c may be in regards to an automation engineering discipline 74c, and discipline artifact 72c may be in regards to an electrical engineering discipline 74d.

A parent and or child relation for a discipline may be visually represented. This representation may be via a position of a marker relative to the node or discipline artifact 172a. Referring FIG. 9 both a parent relation and a child relation are illustrated. A marker 170, 270 may be provided to indicate the parent and/or child relation. Similarly to the description above for marker 70 the markers 170, 270 may illustrate an open or closed state. In the case of a marker of a parent/child relation, in the close state the relation is not shown but in the open state the relation is shown. In FIG. 9 both markers 170, 270 indicate a closed state.

According to the embodiment of FIG. 9, marker 170 located to the left of discipline artifact 172b indicates that a parent is related to the discipline artifact. This makes discipline artifact 172b a child to parent which is not displayed due to the collapsed state indicated by marker 170. Marker 270 located to the right of discipline artifact 172c indicates that discipline artifact 172c indicates is a parent. The child to discipline artifact 172c is not displayed due to the collapsed state shown by marker 270.

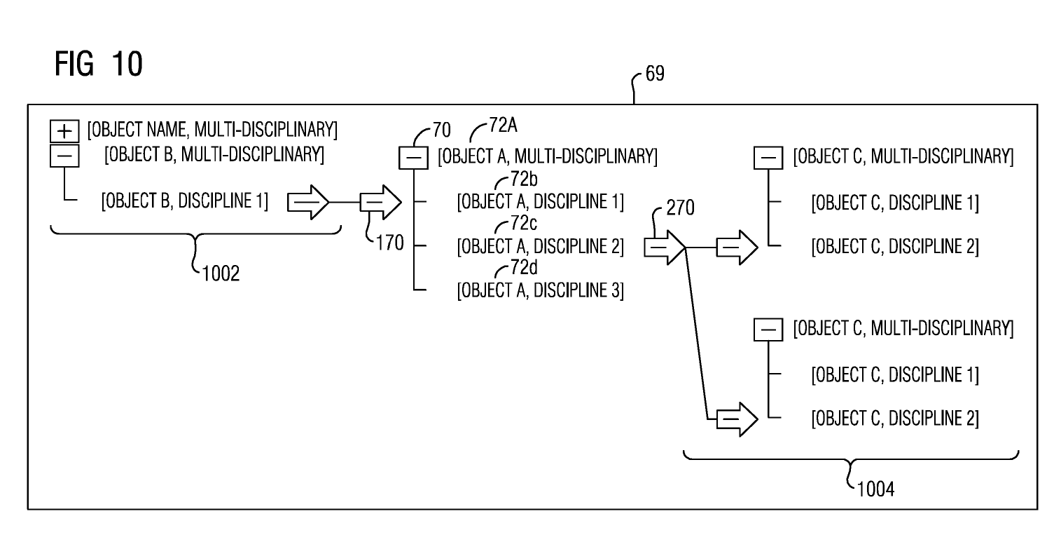

In FIG. 10 both markers 170, 270 of FIG. 9 indicate an open state and the parent child relations are shown. The parent 1002 of discipline artifact 172b is displayed in the open state indicated in marker 170. Additionally the child 1004 of discipline artifact 174c is displayed in the open state indicated in marker 270. The constituents of the parent and/or child nodes may also be displayed.

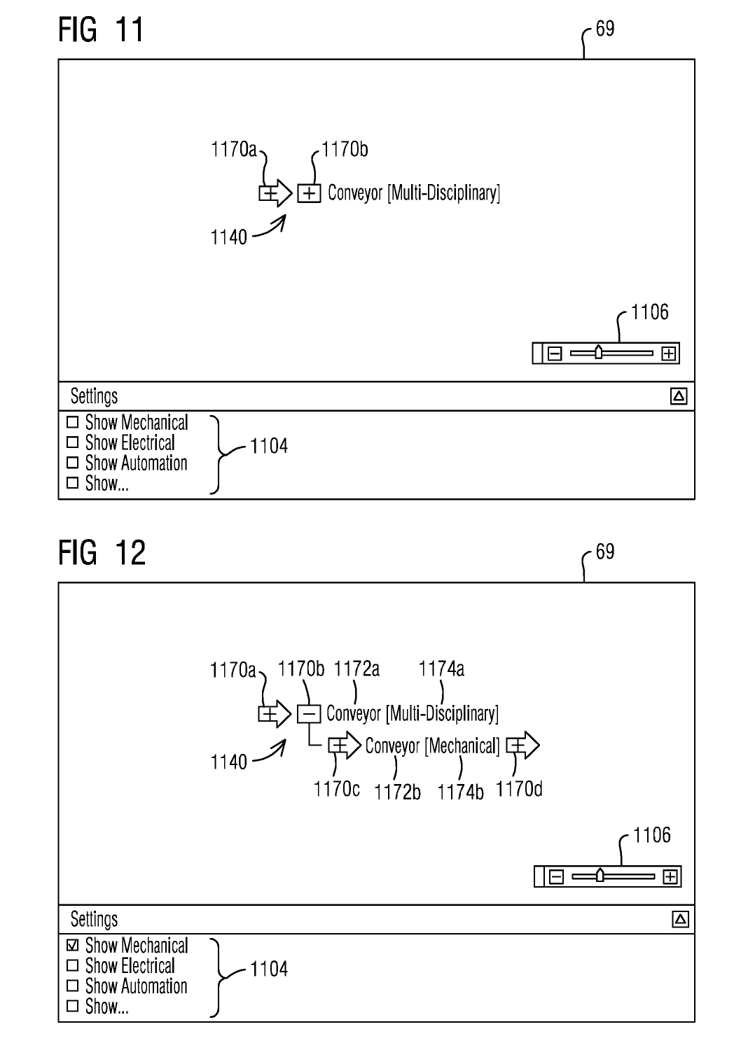

FIGS. 11-18 illustrate various embodiments using a conveyor as an example of a node in the multi-discipline-system. According the different disciplines the conveyor has different attributes regarding physical characteristics, a behavior, a condition and so forth. A mechanical discipline may include information on mechanical devices needed to drive the conveyor such a motor. In turn the motor may be viewed in regards to several disciplines. For example, the mechanical parts that make up the motor may be relevant in the mechanical discipline, the electrical components and behaviors relevant in the electrical discipline and the behaviors and conditions relevant in the automation view. Further the motor may include a motor starter may be relevant as a part of the motor in the electrical and the mechanical disciplines.

The marker 1170a is in a closed state and indicates the node 1140 is a child. Marker 1170b is also in a closed state and indicates the node 1140 comprises discipline artifacts. Check-box 1104 is provided control the display selecting one or more disciplines to display data regarding the node, for example, mechanical, electrical and automation. An interface may be provided to enlarge or reduce the display. For example, a slider 1106 may be provided to adjust the size of the display where sliding in one direction increases the display and in the opposite shrinks the display. In addition to the visualization, the nodes and edges may be moved within the display. The position and alignment of the nodes and edges may occur automatically according to optimization algorithms.

FIG. 12 shows and expansion of node 1140 after a user select the mechanical discipline via the input device. Indicators 1172a indicate the name of the node is conveyor. Indicator 1174a indicates a relationship between the node and the multi-discipline system. Indicator 1172b indicates a conveyor discipline artifact for the mechanical discipline as shown in indicator 1174b. Markers 1170c and 1170b indicate parent/child relations.

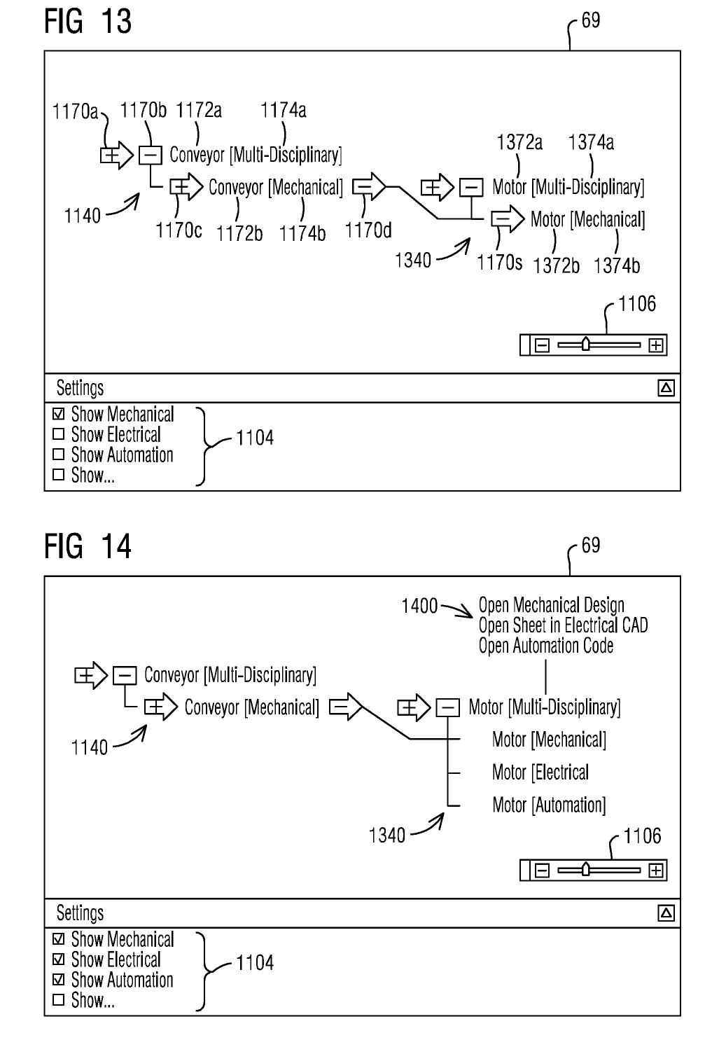

An expansion of the conveyor artifact 1072b for the mechanical discipline is illustrated in FIG. 13. Marker 1170d is in an open state and accordingly node 1340, which is a child in relation conveyor artifact 1072b, is displayed. Node 1340 is for a motor of a conveyor. The indicators 1372a, 1372b, 1374a, 1374b are similar to those of 1172a, 1172b, 1174a, 1174b in that they indicate the name/discipline artifact and relation to the system or discipline.

In FIG. 14 multiple disciplines are selected to be displayed. By way of example, the mechanical, electrical and automation disciplines are selected. Accordingly, the currently displayed nodes 1140, 1340 are expanded. FIG. 14 illustrates that the motor is represented in multiple disciplines including the mechanical, electrical and automation disciplines. Data specific to a discipline may be accessible from the nodes 1140, 1340. For example, an interface 1400 may allow a user to select to open discipline specific data.

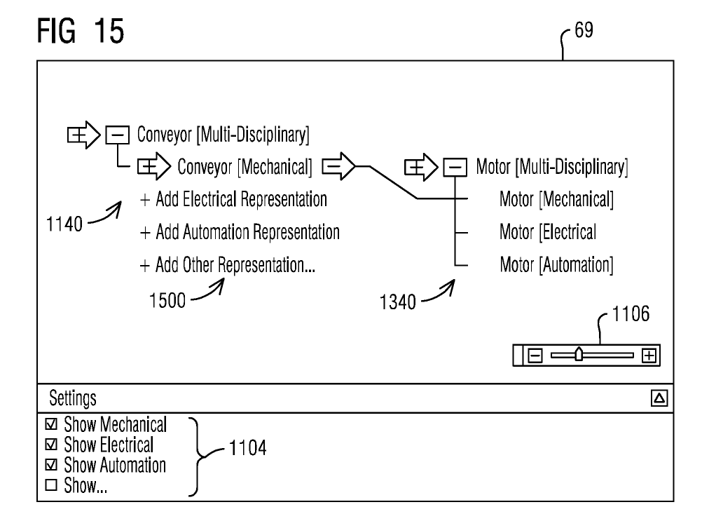

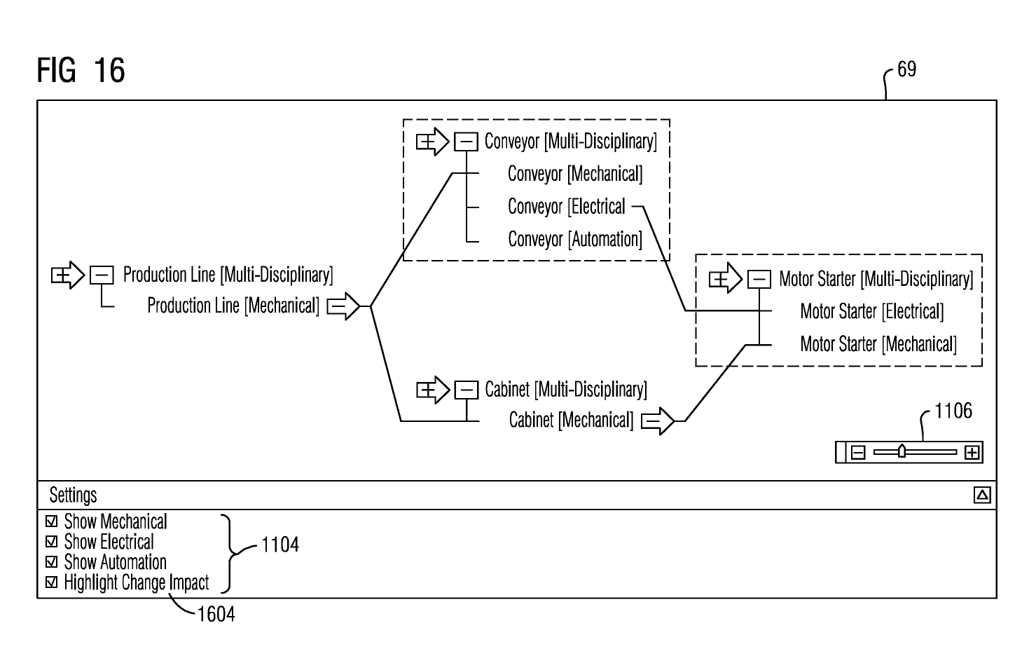

The conveyor according to FIG. 14 is not represented in the electrical and automation disciplines. Referring to FIG. 15 an interface 1500 may be provided to add representations of a node. For example, the electrical and/or automation representation of the conveyor may be added. Further it may be that a representation is deleted from the display. This would automatically delete any children or parents which are associated to the deleted node or discipline artifact. In contrast the data may be highlighted so that the user may see the data predicted to be deleted. Other impacts may be displayed as the user controls changes to display data to be added or deleted as illustrated in FIG. 16. FIG. 16 illustrates a change impact analysis as a visualization for other data. This may be useful when an engineer prepares a change in his engineering and due to the complex nature of data connection and dependencies is unsure about what data will be impacted when submitting the change. So he can see a preview of which disciplines and which data in those disciplines will be impacted. The box overlay shown by the dashed lines is used as an example how the visualized may be represented.

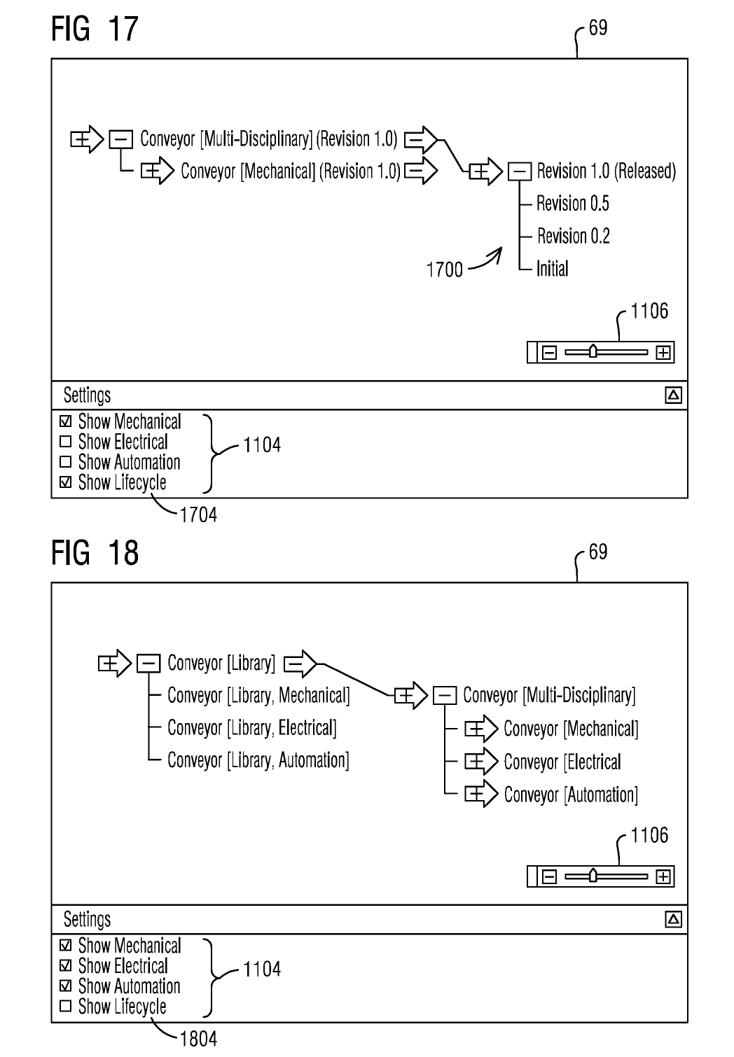

In multi-disciplinary systems, the data is changed throughout the project. Snapshots of the data may be preserved for historical purposes. These snapshots are referred to as a revision or a version and the list of versions made during an evolution of the projected is referred to as revision history. Revision history may be provided as illustrated in FIG. 17. The revision history shows a version in which data pertaining to the node and/or discipline artifact was modified. The version may be identified by text, number identifies and so forth. The version may include a baseline. The baseline is a specific revision which represents a useful state of the project such a product release. Regarding FIG. 17, the initial version may be considered a baseline. Revision 1.0 (Released) may be considered a baseline to further versions. Revision 0.2 and Revision 0.5 would be interim versions.

An interface 1704 may be used to select to display what revisions are available 1700. The displayed available revisions 1700 may be a further interface with allows the user to deter-mine which version will be visualized. This may be useful to see the historical changes made during the evolution of a product. Further, this may allow a user to recreate versions.

Referring to FIG. 18, illustrates visualization of reuse of data from libraries. It is common for engineers to build libraries of reusable data that may be used many times in a project to save time. For example, in an airport baggage handling system there may be about 10000 conveyors where many of them share a common engineering approach. So the engineer will pre-pare an engineering template (in this case multi-disciplinary) in his library and use it in the project context say 1000 times.

Now the visualization in FIG. 18 allows to trace from the conveyor instance in the project back to the source template in the library. This can be useful for finding out if a template was used to create the object, which version of the library template was used or when changes to the template are necessary.

While the embodiment are described using symbols “+” and “−” in the markers one skilled in the art would recognize that representations may be used to indicate open and close state. For example, the open and closed state of the marker may be represented by other symbols, by a numeric representation which corresponds to the number of hidden relations in a closed state, by text or by color.

Although identifier are described above as text other identifiers may used. For example a icon, shading or color.

Embodiments described use the position of marker being to the left or right of to indicate a parent or child relation. One skilled in the art would recognize that the positions described may be reversed. Moreover other indicators may be used to provide parent and/or child relations. Such as color, text or icons.

While the above description is in regards to the use of conveyor, the use of specific nodes and disciplines are just examples and not to be limiting.

Although an exemplary embodiment of the present disclosure has been described in detail, those skilled in the art would understand that various changes, substitutions, variations, and improvements disclosed herein may be made without departing from the spirit and scope of the disclosure in its broadest form.

None of the description in the present disclosure should be read as implying that any particular element, step, or function is an essential element which must be included in the claim scope. Moreover, none of these claims are intended to invoke paragraph sic of 35 U.S.C. § 112 unless the exact words “means for” are followed by a participle.

What is claimed is:

1. A system comprising:
a processor;
a visualization unit associated with the processor; and
a storage unit associated with the processor, the storage unit comprising data for multiple disciplines and a meta model;
the processor configured to retrieve data from and to store data on the storage unit, process an input controlling a visualization based on the meta model and to update a display on the visualization unit based on the input received from an input device.

2. The system according to claim 1,
wherein the display includes a plurality of nodes each represented in multiple disciplines and edges between the nodes.

3. The system according to claim 1,
wherein based on the received input the visualization predicts impacts to the multiple disciplines in order to simulate changes.

4. The system according to claim 1,
wherein a discipline to be displayed is controlled via the input received by input device 65.

5. The system according to claim 2,
wherein information for one of the plurality of nodes is expanded via the input.

6. The system according to claim 2,
wherein information for one of the plurality of nodes is collapsed via the input.

7. The system according to claim 1,
wherein the display includes a constituents of a node.

8. The system according to claim 1,
wherein the display includes a parent and/or child relation between nodes of different disciplines.

9. The system according to claim 1,
wherein the display includes revision history.

10. A method, comprising:
receiving input to control a visualization of a multi-discipline system based on a meta model; and
updating the display on the visualization unit according to an input received from an input device.

11. The method according to claim 10,
wherein the display includes a plurality of nodes each represented in multiple disciplines and edges between the nodes.

12. The method according to claim 10,
wherein based on the received input the visualization predicts impacts to the multiple disciplines in order to simulate changes.

13. The method according to claim 10,
wherein a discipline to be displayed is controlled via the input.

14. The method according to claim 11,
wherein information for one of the plurality of nodes is expanded via the input.

15. The method according to claim 10,
wherein information for one of the plurality of nodes is collapsed via the input.

16. The method according to claim 10,
wherein the display includes a constituents of a node.

17. The method according to claim 10,
wherein the display includes a parent and/or child relation between nodes of different disciplines.

18. The method according to claim 10,
wherein the display includes revision history.

19. The method according to claim 10, comprising
receiving input to delete a discipline artifact;
removing the discipline artifact from the display; and
automatically removing from the display all parent and child relations of the discipline artifact.

20. The method according to claim 10, comprising
receiving input to add a discipline artifact to a node.
